(19) United States
(12) Patent Application Publication
(10) Pub. No.: US 2024/0262749 A1
(43) Pub. Date: Aug. 8, 2024

(54) ADJUVANT FOR INCREASING THE SHORT-TERM MECHANICAL STRENGTH OF A HYDRAULIC COMPOSITION WITH A REDUCED CLINKER CONTENT

(71) Applicant: CHRYSO, Courbevoie (FR)

(72) Inventors: Caroline AUTIER, AUTRUY SUR JUINE (FR); Vanessa KOCABA, CRETEIL (FR)

(21) Appl. No.: 18/567,960

(22) PCT Filed: Jun. 9, 2022
(86) PCT No.: PCT/EP2022/065652

§ 371 Date: Dec. 7, 2023

(30) Foreign Application Priority Data
Jun. 9, 2021 (FR) FR2106078

(51) Int. Cl. C04B 28/04; C04B 14/10; C04B 14/28; C04B 22/06; C04B 22/08; C04B 22/10; C04B 22/12; C04B 22/14; C04B 24/04

(52) U.S. Cl. CPC C04B 28/04; C04B 14/10; C04B 14/28; C04B 22/062; C04B 22/085; C04B 22/10; C04B 22/124; C04B 22/147; C04B 24/04; C04B 2201/50

(57) ABSTRACT

This relates to the use, for improving the mechanical strength of a hydraulic composition based on a cement composition including: from 20 to 64% by weight of clinker; from 5 to 60% by weight of activated clay; from 0 to 35% by weight of limestone; and from 0 to 10% by weight of calcium sulfate, the proportions being relative to the dry weight of the cement composition, of from 0.2 to 5.0% by weight relative to the dry weight of cement composition, preferably from 0.2 to 1.0% by weight relative to the dry weight of cement composition, of at least one adjuvant including at least one alkali metal salt chosen from alkali metal formate, carbonate, chloride, hydroxide, oxalate, thiocyanate, silicate, sulfate or nitrate salts, or a mixture thereof.

### CROSS-REFERENCE TO RELATED APPLICATIONS

This application is the US national stage of PCT/EP2022/065652, filed Jun. 9, 2022 and designating the United States, which claims the priority of FR 2106078, filed Jun. 9, 2021. The entire contents of each foregoing application are incorporated herein by reference.

### BACKGROUND OF THE INVENTION

### Field of the Invention

The present invention relates to the use of an admixture for improving the mechanical strength, particularly the short short-term strength for example of up to 2 days, of a hydraulic composition based on a cement composition comprising a high proportion of activated clay and a reduced content of clinker, and to an admixed cement composition and uses thereof.

### Description of the Related Art

Usual cement compositions comprise a high proportion of clinker. For example, a cement composition in accordance with standard NF EN 197-1 (April 2012) «Composition, specifications and conformity criteria for common cements» comprises at least 65% by weight of clinker.

It is sought to lower the clinker content of cement compositions to reduce the carbon footprint thereof, whilst maintaining their mechanical and rheological properties. New cement compositions in which part of the clinker is replaced by activated clays and limestone are emerging, as described in particular in the provisional standard prEN 197-5 (September 2020) «Cement—Part 5: Portland-composite cement CEM II/C-M and Composite cement CEM VI».

Patent application WO 2010/130511 describes a cement composition comprising activated clay.

However, the acquiring of mechanical strength in particular short-term strength and preferably mechanical strength at 2 days is not facilitated.

Most admixtures known to improve the mechanical strength of a hydraulic composition based on a cement composition with usual clinker content do not perform sufficiently well to improve the mechanical strength of a hydraulic composition based on a cement composition having a reduced clinker content.

Patent WO 2019/094060 describes a cement composition comprising:
from 30 to 95% by weight of hydratable cement, limestone, or mixture thereof,
from 5 to 70% by weight of calcined clay comprising from 1 to 15% by weight of Fe₂O₃,
from 0.002 to 0.200% by weight of tertiary alkanolamine,
   the proportions been relative to the dry weight of cement composition. The tertiary alkanolamine allows improved pozzolanic reactivity of the activated clay.

There is a need to develop alternative methods for improving mechanical strength, preferably over the short-term (for example 2 days) of hydraulic compositions based on cement compositions having a reduced clinker content.

A further objective is to provide a cement composition with low clinker content and comprising activated clays allowing the obtaining of a hydraulic composition having good mechanical properties, mechanical strength in particular, and in particular over the short-term for example at 2 days.

### SUMMARY OF THE INVENTION

A first subject of the invention, to improve the mechanical strength of a hydraulic composition based on a cement composition, comprising:
from 20 to 64% by weight of clinker,
from 5 to 60% by weight of activated clay,
from 0 to 35% by weight of limestone,
from 0 to 10% by weight of calcium sulfate,
the proportions being relative to the dry weight of the cement composition, concerns the use of from 0.2 to 5.0% by weight relative to the dry weight of cement composition, preferably from 0.2 to 1.0% by weight relative to the dry weight of cement composition, of at least one admixture comprising at least one alkali metal salt chosen from alkali metal formate, carbonate, chloride, hydroxide, oxalate, thiocyanate, silicate, sulfate or nitrate salts, or a mixture thereof.

Preferably, the hydraulic composition of the invention does not comprise calcium chloride.

The hydraulic composition of the invention is preferably a composition of concrete, mortar or cement creed. In addition to the cement composition it comprises water, an aggregate and optionally one or more mineral additions.

By «aggregates», it is meant an assembly of mineral grains having a mean diameter of between 0 and 125 mm. Depending on their diameter, the aggregates are classified in one of the six following families: fillers, fine sand, coarse sand, gravel sand, gravel and ballast (in standard NF P 18-545 (September 2011) «Aggregates—Defining elements, conformity and coding». The aggregates that are most used are the following:
fillers, having a diameter of less than 2 mm and for which at least 85% of the aggregate has a diameter of less than 1.25 mm, and at least 70% of the aggregate has a diameter of less than 0.063 mm,
sands having a diameter of between 0 et 4 mm (in standard NF EN 13242+A1 (March 2008) «Aggregates for unbound and hydraulically bound materials for use in civil engineering work and road construction», the diameter possibly reaching 6 mm),
gravel sand having a diameter greater than 6.3 mm,
gravel having a diameter of between 2 mm and 63 mm.

Sands are therefore included in the definition of aggregate according to the invention.

Fillers can be of lime or dolomitic origin in particular.

The expression «mineral additions» designates pozzolanic materials (such as defined in standard NF EN 197-1 (April 2012) «Composition, specifications and conformity criteria for common cements» paragraph 5.2.3), fly ash (such as defined in standard NF EN 197-1 (April 2012) «Composition, specifications and conformity criteria for common cements» paragraph 5.2.4), burnt shale (such as defined in standard NF EN 197-1 (April 2012) «Composition, specifications and conformity criteria for common cements» paragraph 5.2.5), limestones (such as defined in standard NF EN 197-1 (April 2012) «Composition, specifications and common criteria for common cements» paragraph 5.2.6) or silica fume (such as defined in standard NF EN 197-1 (April 2012) «Composition, specifications and conformity criteria for common cements«paragraph 5.2.7), or mixtures thereof. The expression «mineral additions» also designates slags (such as defined in cement standard NF EN 197-1(2012) paragraph 5.2.2), basic oxygen furnace slag (BOF). Other additions not currently recognized by standard NF EN 197-1 (April 2012) «Composition, specifications and common criteria for common cements», can also be used. These particularly concern metakaolins such as type A metakaolins conforming to standard NF P 18-513 (August 2012), «Metakaolin Flash» or calcined clays, siliceous additions such as siliceous additions of Qz mineralogy conforming to standard NF P 18-509 (September 2012) «Additions for concrete», aluminosilicates in particular of inorganic geopolymer type, aluminosilicates containing iron oxides such as bauxite residues, norite or aplite from excavation work. The proportions of mineral additions and their type can also conform to the provisional standard prEN 197-5 (September 2020) «Cement—Part 5: Portland-composite cement CEM II/C-M and Composite cement CEM VI>, which defines CEM II/C-M cements comprising between 50 and 64% by weight of clinker and from 36 to 50% by weight of blast furnace slag, and CEM VI cement comprising from 35 to 49% by weight of clinker, from 31 to 59% by weight of blast furnace slag and from 6 to 20% by weight of mineral additions such as defined above.

The admixture, in the proportions used, advantageously allows the obtaining of a hydraulic composition having good mechanical strength, short-term strength in particular. By short-term mechanical strength it is meant to designate mechanical strength at 16 hours, 1 day and 2 days, preferably at 2 days. Such mechanical strength is measured in accordance with standard NF EN 196-1 (September 2016) «Methods of testing cement—Part 1: Determination of strength». Preferably the admixture allows the obtaining of a gain in mechanical strength of at least 9% compared with the cement composition without admixture, preferably of at least 15%, preferably from 20 to 45%, preferably from 25 to 35%, at 2 days.

Therefore, and preferably, the present application, to improve the mechanical strength at 2 days by at least 9%, preferably by at least 15%, preferably by 20 to 45%, preferably by 25 to 35% compared with a cement composition without admixture, of a hydraulic composition based on a cement composition comprising:
from 20 to 64% by weight of clinker,
from 5 to 60% by weight of activated clay,
from 0 to 35% by weight of limestone,
from 0 to 10% by weight of calcium sulfate,
the proportions being relative to the dry weight of the cement composition, concerns the use of from 0.2 to 5.0% by weight relative to the dry weight of cement composition, preferably from 0.2 to 1.0% by weight relative to the dry weight of cement composition, of at least one admixture comprising at least one alkali metal salt chosen from alkali metal formate, carbonate, chloride, hydroxide, oxalate, thiocyanate, silicate, sulfate or nitrate salts, or a mixture thereof.

Preferably, the hydraulic composition of the invention does not comprise calcium chloride.

The admixture is generally used in a proportion of 0.2 to 5.0% by weight, in particular of 0.5 to 1.0% by weight, preferably from 0.6 to 1.0% by weight, the proportions being by weight relative to the dry weight of the cement composition.

The admixture of the invention can be used when grinding the cement composition or else when preparing the hydraulic composition, preferably when mixing with water.

Preferably, the alkali metal salt is a potassium salt or a sodium salt or a lithium salt, preferably a potassium salt or a sodium salt.

Preferably, the alkali metal salt is chosen from among alkali metal formate, carbonate, chloride, hydroxide, oxalate, sulfate or nitrate salts, or a mixture thereof.

Preferably, the alkali metal salt is chosen from among potassium or sodium or lithium salts, preferably potassium or sodium formate, carbonate, chloride, hydroxide, oxalate, sulfate or nitrate salts, or a mixture thereof.

The cement composition of the invention comprises:
from 20 to 64% by weight, preferably from 35 to 60% by weight of clinker,
from 5 to 60% by weight of activated clay,
from 0 to 35% by weight of limestone,
from 0 to 10% by weight of calcium sulfate,
the proportions being by weight relative to the dry weight of the cement composition.

Preferably, the hydraulic composition of the invention does not comprise calcium chloride.

Said cement composition is not usual in that it has a low proportion of clinker and a high proportion of activated clay. The cement composition is in particular of LC³ type («limestone calcined clay cement» such as described in the article by Karen Scrivener et al., Calcined clay limestone cements (LC³), Cement and Concrete Research, Volume 114, December 2018, Pages 49-56), and/or it can be CEM II/C-M-Q-L or CEM II/C-M-Q-LL according to provisional standard prEN 197-5 (September 2020) «Cement—Part 5: Portland-composite cement CEM II/C-M and Composite cement CEM VI».

The clinker is particularly Portland clinker, preferably Portland clinker such as defined in the work «Cement Chemistry». Harry F. W. Taylor. Edition, 2, Academic Press, 1990).

The cement composition comprises from 0 to 35% by weight, preferably from 10 to 30% by weight of limestone, the proportions being by weight relative to the dry weight of the cement composition.

The limestone is preferably such as defined in standard NF EN 197-1 (April 2012) «Composition, specifications and conformity criteria for common cements» paragraph 5.2.6.

The cement composition comprises from 0 to 10% by weight, preferably from 1.0 to 5.0% by weight of calcium sulfate, the proportions being by weight relative to the dry weight of the cement composition.

The calcium sulfate can be in dehydrate or hydrate form, or mixture thereof. The calcium sulfate hydrate can be a monohydrate, dihydrate or mixture thereof. The calcium sulfate dihydrate of formula CaSO₄.2H₂O is gypsum. Gypsum is therefore an example of calcium sulfate.

By «activated clay», it is meant a clay that has been subjected to dehydroxylation. Such as used herein, the term «dehydroxylation» refers to the loss by a clay of one or more hydroxy groups (OH) in water form (H2O).

Preferably, the activated clay is a kaolinic clay (also called kaolinitic) that has been activated. By «kaolinic clay», it is meant a clay which comprises kaolinite. A «kaolinic clay that has been activated» is a kaolinic clay in which at least part of the kaolinite has been dehydroxylated to metakaolin, preferably no longer including any kaolinite. For example, when heating clayey mineral kaolinite to 300 to 600° C., some water is lost according to the following reaction:

Al₂Si₂O₅(OH)₄→Al₂Si₂O₇+2H₂O

Therefore, a kaolinic clay that has been activated comprises and is even composed of metakaolin. Metakaolin is highly reactive in the presence of water and portlandite to form hydrate phases, in particular calcium alumina silicate hydrate (C-A-S-H) and strätlingite.

In the meaning of the application, kaolinic clay that has been activated may comprise residual kaolinite (which was not dehydroxylated during activation) in an amount such as measured by thermogravimetric analysis (ATG), typically by temperature rise between 30 and 900° C., at a heating rate for example of 10° C./min, which allows quantification of the loss of mass corresponding to the water released by the clay. This content of residual kaolinite is generally less than or equal to 50% by weight, typically less than or equal to 40% by weight, in particular less than or equal to 30% by weight, preferably less than or equal to 20% by weight, and most preferably less than or equal to 10% by weight relative to the weight of the activated clay, the proportions being by weight relative to the dry weight of the cement composition. Kaolinic clay that has been activated can be free of kaolinite (in which case dehydroxylation was complete).

Dehydroxylation can be conducted by thermal, mechanical and/or chemical treatment.

Mechanical treatment for example can be the treatment described in the article by Aleksandra Mitrović et al., Preparation of pozzolanic addition by mechanical treatment of kaolin clay, International Journal of Mineral Processing, Volume 132, 2014, 59-66.

Thermal treatment is by calcining, generally at a temperature of between 400 and 700° C. (dehydroxylation temperature). In this case, it is known as kaolinic clay that has been calcined.

Calcining is most often carried out in a rotary kiln in which the clay is charged. The kaolin is at least partially converted to an amorphous and reactive phase having strong pozzolanic properties, called metakaolin. The calcined clay is then milled. Calcining can be conducted using the «flash» method whereby the clay is milled and the fine particles are calcined within a few seconds in a kiln.

Irrespective of the activation method used (in particular mechanical or thermal), the activated clay can be subjected to additional activation via chemical route by means of compounds capable of complexing cations, preferably compounds capable of complexing calcium.

The kaolinic clay that has been activated can be IMERYS METASTAR 501 for example.

Preferably, the cement composition comprises more than 30% by weight of calcined clay and up to 60% by weight of calcined clay, preferably from 35 to 60% by weight of calcined clay, the proportions being by weight relative to the dry weight of the cement composition.

Preferably, in the cement composition, the weight ratio of activated clay weight relative to the weight of limestone is from 1:2 to 5:1, preferably from 1:1 to 3:1, most preferably from 3:2 to 5:2.

Preferably, in the cement composition, the weight ratio of clinker weight relative to the weight of activated clay is from 1:4 to 4:1, in particular from 1:1 to 3:1, preferably from 3:2 to 5:2.

Preferably, in the cement composition the weight ratio of clinker weight relative to limestone weight is from 1:1 to 10:1, in particular from 3:1 to 5:1.

Preferably, the cement composition contains:
from 5.0 to 25% by weight, preferably from 6.0 to 20% by weight of Al₂O₃,
from 25 to 55% by weight, preferably from 40 to 50% by weight of CaO,
from 20 to 40% by weight, preferably from 22 to 35% by weight of SiO₂,
from 2.0 to 10% by weight, preferably from 2.0 to 5.0% by weight of SO₃, and/or
from 0.1 to 10% by weight, preferably from 0.5 to 8.0% by weight of Fe₂O₃,
relative to the sum of the dry weights of clinker, activated clay, limestone, and calcium sulfate.

Other admixtures can be used in the present invention in addition to the above-mentioned admixtures. These admixtures can be chosen by skilled persons from among typical admixtures of cement compositions and hydraulic compositions. Particular mention can be made of alkanolamines, glycols, glycerols, water-reducing and high-range water-reducing admixtures, surfactants, carboxylic acids and salts thereof such as acetic, adipic, gluconic, formic, oxalic, citric, maleic, lactic, tartaric, malonic acids and mixtures thereof, defoaming additives, air-entraining additives and/or grinding agents, set retarding agents.

In the present invention, among set retarding agents, particular mention can be made of sugar-, molasses- or vinasse-based set retarders.

Preferably the water reducing and high-range water reducing admixtures are chosen from among:
Sulfonated salts of naphthalene and formaldehyde polycondensates, commonly called polynaphthalene sulfonates or naphthalene superplasticizers;
Sulfonated salts of melamine and formaldehyde polycondensates, commonly called melamine superplasticizers;
Derivatives of lignin such as lignosulfonates;
Sodium gluconate and sodium glucoheptonate;
Polyacrylates;
Polyarylethers (PAEs);
Products based on polycarboxylic acids, in particular polycarboxylate comb copolymers which are branched polymers in which the main chain carries carboxylic groups and the side chains are composed of sequences of polyether type, in particular ethylene polyoxide such as poly [(meth)acrylic acid-graft-ethylene polyoxide]. Particular use can be made of the superplasticizers in the ranges CHRYSO®Fluid Optima, CHRYSO®Fluid Premia and CHRYSO®Plast Omega marketed by CHRYSO;
Products based on polyalkoxylated polyphosphonates, in particular those described in patent EP 0 663 892 (e.g. CHRYSO®Fluid Optima 100).

Preferably, the cement composition does not comprise an alkanolamine.

The hydraulic composition may also comprise other additives known to skilled persons, for example a mineral addition and/or additives such as an air-entraining additive, a defoaming agent, a set accelerator or retarder, a rheology-modifying agent, another fluidizer (plasticizer or superplasticizer), in particular a superplasticizer such as a CHRYSO®Fluid Premia 180 or CHRYSO®Fluid Premia 196 superplasticizer.

A further subject of the invention concerns an admixed cement composition comprising:
from 20 to 64% by weight of clinker,
from 5 to 60% by weight of activated clay,
from 0 to 35% by weight of limestone,
from 0 to 10% by weight of calcium sulfate,
the proportions being relative to the dry weight of the cement composition,
and from 0.2 to 5.0% by weight relative to the dry weight of the cement composition, preferably from 0.2 to 1.0% by weight relative to the dry weight of the cement composition, of at least one admixture comprising at least one alkali metal salt chosen from alkali metal formate, carbonate, chloride, hydroxide, oxalate, thiocyanate, silicate, sulfate or nitrate salts, or a mixture thereof.

Preferably, the alkali metal salts and the amount of these salts are such as described above.

In the meaning of the application, by «admixed cement composition» it is meant a composition comprising the cement composition such a defined above together with the admixture, and by «cement composition» it is meant the cement composition free of admixture.

The embodiments defined above for the cement composition apply to the admixed cement composition.

The admixed cement composition may or may not further comprise a grinding agent.

A third subject of the invention concerns a method for improving the short-term mechanical strength of a hydraulic composition based on a cement composition comprising from 20 to 64% by weight of clinker, from 5 to 60% by weight of activated clay, from 0 to 35% by weight of limestone, from 0 to 10% by weight of calcium sulfate, the proportions being relative to the dry weight of the cement composition, said method comprising the addition of 0.2 to 5.0% by weight relative to the dry weight of the cement composition, preferably from 0.2 to 1.0% by weight relative to the dry weight of the cement composition, of at least one admixture comprising at least one alkali metal salt chosen from alkali metal formate, carbonate, chloride, hydroxide, oxalate, thiocyanate, silicate, sulfate or nitrate salts, or a mixture thereof, to the hydraulic composition.

Preferably, the alkali metal salts and the amount of these salts are such as described above.

Preferably, the admixture allows an increase in mechanical strength of at least 9%, preferably of 15 to 45% at 2 days. Preferably the admixture allows mechanical strength to be increased by at least 20%, preferably by 25 to 35% compared with the mechanical strength obtained for the same hydraulic composition free of admixture.

The admixture can be added to the cement composition at the grinding step or else when preparing the hydraulic composition.

The admixture can be added:
When co-grinding at least two constituents of the cement composition, preferably clinker and calcium sulfate, or activated clay and limestone;
And/or when grinding one of the constituents of the cement composition if milled separately, preferably when grinding activated clay, more preferably when grinding the clinker;
And/or when mixing the components of the cement composition;
And/or when preparing the hydraulic composition, in particular when adding water to mix the cement composition.

The embodiments defined above for the cement composition are applicable for the method of the invention.

A fourth subject of the invention concerns a hydraulic composition comprising (even composed of) the cement composition defined above, water, an aggregate and optionally one or more mineral additions, and from 0.2 to 5.0% by weight relative to the dry weight of the cement composition, preferably from 0.2 to 1.0% by weight relative to the dry weight of the cement composition, of at least one admixture comprising at least one alkali metal salt chosen from alkali metal formate, carbonate, chloride, hydroxide, oxalate, thiocyanate, silicate, sulfate or nitrate salts, or a mixture thereof.

The hydraulic compositions are prepared conventionally by mixing the above-mentioned constituents. The admixture is added at the time of mixing with water, or when grinding the cement composition.

The embodiments defined above for the cement composition apply to the hydraulic composition.

### DETAILED DESCRIPTION

The invention is illustrated in the following examples.

### Example 1: Description of the Cement Compositions

The oxide contents and total equivalent alkalinity (Na₂Oeq) of cement compositions 1 and 2 of LC³ type were determined by X-ray fluorescence, and the contents of kaolinite and amorphous phases of cement compositions 1 and 2 of LC³ type were determined by X-ray Diffraction/Rietveld Refinement as detailed in Table 1.

TABLE 1

| | Chemical | Chemical |
|---|---|---|
| | composition | composition |
| | of cement | of cement |
| | composition 1 | composition 2 |
| | (wt. %) | (wt. %) |
| SiO₂ (X-ray fluorescence) | 26.6 | 26.5 |
| Al₂O₃ (X-ray fluorescence) | 13.4 | 17.2 |
| Fe₂O₃ (X-ray fluorescence) | 2.74 | 2.06 |
| CaO (X-ray fluorescence) | 43.1 | 41.7 |
| Na₂O (X-ray fluorescence) | 0.03 | 0.04 |
| K₂O (X-ray fluorescence) | 0.71 | 0.48 |
| SO₃ (X-ray fluorescence) | 3.11 | 3.09 |
| Na₂Oeq. (═Na₂O + 0.658 | 0.50 | 0.36 |
| K₂O) (X-ray fluorescence) | | |
| Kaolinite Al₂Si₂O₅(OH)₄ | 2.1 | 0.0 |
| (X-ray Diffraction/ | | |
| Rietveld Refinement) | | |
| Amorphous phases (X-ray | 15.0 | 27.8 |
| Diffraction/Rietveld | | |
| Refinement) | | |

The compressive mechanical strength at 2 days of the hydraulic compositions of LC³ type were compared without admixture and in the presence of 1.0% by weight of the claimed admixtures, relative to the dry weight of cement composition.

### Example 2: Effect of the Quantity of Calcined Clay on Mechanical Strength

Different hydraulic compositions were prepared from a mixture of CEM I, activated clay and limestone, with different quantities of each of the constituents.

The compressive mechanical strength at 2 days was evaluated in accordance with standard NF EN 196-1 (September 2016) «Methods of testing cement—Part 1: Determination of strength—Methods for testing cement». The results are given in Table 2 (Compressive mechanical strength at 2 days evaluated according to standard NF EN 196-1 (September 2016) «Methods of testing cement».

TABLE 2

| | Weight | Mechanical |
|---|---|---|
| | ratio clay/ | strength at |
| Hydraulic composition | limestone | 2 days (in MPa) |
| 60.6% weight % CEM I + 5 weight % | 0.15 | 13.0 |
| activated clay + 34.4 weight % | | |
| limestone | | |
| 30 weight % CEM I + 8.9 weight % | 0.15 | 6.3 |
| activated clay + 61.1 weight % | | |
| limestone | | |
| 55 weight % CEM I + 30 weight % | 2.0 | 13.8 |
| activated clay + 15 weight % limestone | | |
| 85 weight % CEM I + 10 weight % | 2.0 | 20.3 |
| activated clay + 5 weight % limestone | | |

These tests show that at an equivalent clay/limestone ratio, the increase in clay concentration in the hydraulic composition leads to a major loss in mechanical strength at 2 days.

### Example 3

A hydraulic composition 1 was prepared from cement composition 1 following the protocol of standard NF EN 196-1 (September 2016) «Methods of testing cement—Part 1: Determination of strength—Methods of testing cement», with a water-to-cement composition ratio of 0.5. The admixture was added when mixing with water. The evaluated admixtures of the invention were sodium formate, potassium carbonate, sodium hydroxide, potassium hydroxide, sodium chloride, potassium chloride, sodium oxalate, sodium sulfate and potassium sulfate. The dosages are expressed as % relative to the dry weight of the cement composition. For comparison, the sodium chloride, calcium chloride and diethanolisopropanolamine were evaluated at 0.02% by weight (usual dosage of admixtures for cement). The compressive mechanical strength at 2 days was evaluated in accordance with standard NF EN 196-1 (September 2016) «Methods of testing cement—Part 1: Determination of strength—Methods of testing cement». The results are given in Table 3 (Compressive mechanical strength at 2 days evaluated according to standard NF EN 196-1 (September 2016) «Methods of testing cement—Part 1: Determination of strength—Methods of testing cement», gain in compressive mechanical strength at 2 days compared win the reference without admixture, and relative gain at 2 days compared with the reference without admixture for the different admixed hydraulic compositions 1).

TABLE 3

| | | Gain in compressive | |
|---|---|---|---|
| | Compressive | mechanical strength at | Relative gain at 2 |
| | mechanical | 2 days compared with | day compared with |
| | strength at | reference without | reference without |
| Hydraulic composition 1 | 2 days (MPa) | admixture (MPa) | admixture (%) |
| Hydraulic composition 1 + 1.0 | 20.5 | +2.5 | +14 |
| weight % sodium formate | | | |
| (invention) | | | |
| Hydraulic composition 1 + 1.0 | 22.7 | +4.8 | +26 |
| weight % potassium | | | |
| carbonate (invention) | | | |
| Hydraulic composition 1 + 1.0 | 25.9 | +7.9 | +44 |
| weight % sodium hydroxide | | | |
| (invention) | | | |
| Hydraulic composition 1 + 1.0 | 19.6 | +3.8 | +24 |
| weight % potassium | | | |
| hydroxide (invention) | | | |
| Hydraulic composition 1 + 0.2 | 19.7 | +3.5 | +22 |
| weight % sodium chloride | | | |
| (invention) | | | |
| Hydraulic composition 1 + 1.0 | 23.7 | +5.7 | +32 |
| weight % sodium chloride | | | |
| (invention) | | | |
| Hydraulic composition 1 + 1.0 | 21.9 | +6.1 | +39 |
| weight % potassium chloride | | | |
| (invention) | | | |
| Hydraulic composition 1 + 1.0 | 21.9 | +3.9 | +22 |
| weight % sodium oxalate | | | |
| (invention) | | | |
| Hydraulic composition 1 + 1.0 | 23.3 | +5.7 | +32 |
| weight % sodium sulfate | | | |
| (invention) | | | |
| Hydraulic composition 1 + 1.0 | 19.5 | +3.7 | +23 |
| weight % potassium sulfate | | | |
| (invention) | | | |
| Hydraulic composition 1 + 1.0 | 22.2 | +4.6 | +26 |
| weight % lithium sulfate | | | |
| (invention) | | | |
| Hydraulic composition 1 + 1.0 | 19.1 | +2.9 | +18 |
| weight % sodium nitrate | | | |
| (invention) | | | |
| Hydraulic composition 1 + 1.0 | 18.9 | +0.9 | +5 |
| weight % calcium hydroxide | | | |
| (comparative for effect of | | | |
| type of salt) | | | |
| Hydraulic composition 1 + | 16.4 | +0.2 | +1 |
| 0.02 weight % sodium | | | |
| chloride (comparative at | | | |
| usual dose) | | | |
| Hydraulic composition 1 + | 18.6 | +0.6 | +3 |
| 0.02 weight % | | | |
| diethanolisopropanolamine | | | |
| (comparative at usual dose) | | | |
| Hydraulic composition 1 + | 18.8 | +0.9 | +4 |
| 0.03 weight % cement | | | |
| additive (amine base) | | | |

The hydraulic compositions of the invention allowed the obtaining of compressive mechanical strengths at 2 days ranging from 2.5 to 7.9 MPa compared with 0.2 to 0.9 MPa for the comparative examples. The gain in compressive mechanical strength at 2 days afforded by the admixtures of the invention varied from 14 to 44%. These results show the greater efficacy of the alkali metal salts compared with calcium, and of the range of claimed dosages compared with usual dosage ranges (0.02%).

### Example 3

A hydraulic composition 2 was prepared from cement composition 2 in conventional manner following the manufacturing protocol for mortars representative of concrete application C25 30 in accordance with standard NF EN 206/CN (December 2014) «Concrete—Specification, performance, production and conformity» with a water-to—cement composition ratio of 0.6. The admixture was added at the time of mixing with water. The admixtures of the invention evaluated at 1.0% relative to the dry weight of the cement composition were sodium formate, potassium carbonate, sodium hydroxide, sodium chloride, sodium oxalate and sodium sulfate. The compressive mechanical strength at 2 days was evaluated on test specimens of size 4×4×16 cm³. The results are given in Table 4: Compressive mechanical strength at 2 days evaluated on test specimens of size 4×4×16 cm³, gain in compressive mechanical strength at 2 days compared with the reference without admixture, and relative gain at 2 days compared with the reference without admixture for the different admixed hydraulic compositions 2).

TABLE 4

| | | Gain in compressive | |
|---|---|---|---|
| | Compressive | mechanical strength at | Relative gain at 2 |
| | mechanical | 2 days compared with | day compared with |
| | strength at | reference without | reference without |
| Hydraulic composition 2 | 2 days (MPa) | admixture (MPa) | admixture (%) |
| Hydraulic composition | 11.0 | +1.3 | +13 |
| 2 + 1.0 weight % sodium | | | |
| formate (invention) | | | |
| Hydraulic composition | 11.2 | +1.5 | +15 |
| 2 + 1.0 weight % | | | |
| potassium carbonate | | | |
| (invention) | | | |
| Hydraulic composition | 13.8 | +4.1 | +42 |
| 2 + 1.0 weight % sodium | | | |
| hydroxide (invention) | | | |
| Hydraulic composition | 10.5 | +0.8 | +9 |
| 2 + 1.0 weight % sodium | | | |
| chloride (invention) | | | |
| Hydraulic composition | 12.4 | +2.7 | +28 |
| 2 + 1.0 weight % sodium | | | |
| oxalate (invention) | | | |
| Hydraulic composition | 12.4 | +2.7 | +28 |
| 2 + 1.0 weight % sodium | | | |
| sulfate (invention) | | | |

The admixtures of the invention allowed an increase in the compressive strength of the materials at 2 days of 0.8 to 4.1 MPa, i.e. a gain of 9.0 to 42% compared with the reference without admixture.

1. Method for improving the mechanical strength of a hydraulic composition based on a cement composition comprising:
from 20 to 64% by weight of clinker,
more than 30% and up to 60% by weight of activated clay,
from 0 to 35% by weight of limestone,
from 0 to 10% by weight of calcium sulfate,
the proportions being relative to the dry weight of the cement composition, comprising the addition to said hydraulic composition of 0.2 to 5.0% by weight relative to the dry weight of cement composition, of at least one admixture comprising at least one alkali metal salt selected from the group consisting of alkali metal formate, carbonate, chloride, hydroxide, oxalate, thiocyanate, silicate, sulfate or nitrate salts, or a mixture thereof.

2. (canceled)

3. An admixed cement composition comprising:
from 20 to 64% by weight of clinker,
more than 30% and up to 60% by weight of activated clay,
from 0 to 35% by weight of limestone,
from 0 to 10% by weight of calcium sulfate,
the proportions being relative to the dry weight of the cement composition, and from 0.2 to 5.0% by weight relative to the dry weight of the cement composition, of at least one admixture comprising at least one alkali metal salt selected from the group consisting of alkali metal formate, carbonate, chloride, hydroxide, oxalate, thiocyanate, silicate, sulfate or nitrate salts, or a mixture thereof.

4. A method for improving the mechanical strength at 2 days of a hydraulic composition based on a cement composition, by at least 9% compared with the cement composition without admixture, said cement composition comprising:
from 20 to 64% by weight of clinker,
from 5 to 60% by weight of activated clay,
from 0 to 35% by weight of limestone,
from 0 to 10% by weight of calcium sulfate,
the proportions being relative to the dry weight of the cement composition, comprising the addition to said hydraulic composition of 0.2 to 5.0% by weight relative to the dry weight of cement composition, of at least one admixture comprising at least one alkali metal salt selected from the group consisting of alkali metal formate, carbonate, chloride, hydroxide, oxalate, thiocyanate, silicate, sulfate or nitrate salts, or a mixture thereof.

5. A hydraulic composition comprising:
a cement composition comprising:
from 20 to 64% by weight of clinker,
more than 30% and up to 60% by weight of activated clay,
from 0 to 35% by weight of limestone,
from 0 to 10% by weight of calcium sulfate,
the proportions being relative to the dry weight of the cement composition
from 0.2 to 5.0% by weight relative to the dry weight of cement composition, of at least one admixture comprising at least one alkali metal salt selected from the group consisting of alkali metal formate, carbonate, chloride, hydroxide, oxalate, thiocyanate, silicate, sulfate or nitrate salts, or a mixture thereof,
at least one aggregate, and
optionally one of more mineral additions.

6. The method according to claim 1, wherein the admixture is selected from the group consisting of sodium or potassium or lithium salts, or a mixture thereof.

7. The method according to claim 1, wherein the hydraulic composition does not comprise calcium chloride.

8. The admixed cement composition according to claim 3, wherein the admixture is selected from the group consisting of sodium or potassium or lithium salts, or a mixture thereof.

9. The admixed cement composition according to claim 3, wherein it does not comprise calcium chloride.

10. The method according to claim 4, wherein the admixture is selected from the group consisting of sodium or potassium or lithium salts, or a mixture thereof.

11. The method according to claim 4, wherein the hydraulic composition does not comprise calcium chloride.

12. The hydraulic composition according to claim 5, wherein the admixture is selected from the group consisting of sodium or potassium or lithium salts, or a mixture thereof.

13. The hydraulic composition according to claim 5, wherein it does not comprise calcium chloride.

14. The method according to claim 6, wherein the admixture is selected from the group consisting of formate, carbonate, chloride, hydroxide, oxalate, sulfate or nitrate salts, or a mixture thereof.

15. The admixed cement composition according to claim 8, wherein the admixture is selected from the group consisting of formate, carbonate, chloride, hydroxide, oxalate, sulfate or nitrate salts, or a mixture thereof.

16. The method according to claim 10, wherein the admixture is selected from the group consisting of formate, carbonate, chloride, hydroxide, oxalate, sulfate or nitrate salts, or a mixture thereof.

17. The hydraulic composition according to claim 12, wherein the admixture is selected from the group consisting of formate, carbonate, chloride, hydroxide, oxalate, sulfate or nitrate salts, or a mixture thereof.
